(19) United States
(12) Patent Application Publication
(10) Pub. No.: US 2018/0022449 A1
(43) Pub. Date: Jan. 25, 2018

(54) ROTOR SWASHPLATE ACTUATOR POSITION SYNCHRONIZATION

(71) Applicant: Sikorsky Aircraft Corporation, Stratford, CT (US)

(72) Inventors: Nilesh Sahani, Monroe, CT (US); Lee Salway, Wallingford, CT (US); David Anthony DeFusco, West Haven, CT (US)

(21) Appl. No.: 15/597,868

(22) Filed: May 17, 2017

Related U.S. Application Data
(60) Provisional application No. 62/366,257, filed on Jul. 25, 2016.

(51) Int. Cl. B64C 27/605; B64C 27/56; B64C 27/06

(52) U.S. Cl. CPC B64C 27/605; B64C 27/06; B64C 27/56

(57) ABSTRACT

A method of synchronizing a plurality of actuators includes sensing a position of the plurality of actuators associated with a swashplate and calculating a measured collective position and a measured cyclic position based on the sensed position. A collective position error and a cyclic position error are determined from the measured collective position and the measured cyclic position. The cyclic position error is compared to a predetermined threshold to evaluate whether operation of the plurality of actuators is within limits of the swashplate.

### CROSS REFERENCE TO RELATED APPLICATIONS

This application claims the benefit of U.S. Provisional Application No. 62/366,257, filed Jul. 25, 2016, the contents of which are incorporated by reference in its entirety herein.

### STATEMENT OF FEDERAL SUPPORT

This invention was made with government support with the United States Arm under Contract No.: W911W6-13-2-0003. The government has certain rights in the invention.

### BACKGROUND OF THE INVENTION

The subject matter disclosed herein relates to a rotary wing aircraft, and more particularly, to operation of a rotary wing aircraft in the event of an actuator failure or loss of power.

Rotary-wing aircraft, such as helicopters, have at least one rotor for providing lift and propulsion forces. These rotors have at least two airfoil blades connected to a hub, and the hub is mounted on a rotatable shaft driven by an engine or motor. A pitch angle of the blades is typically adjustable through a swashplate assembly and a linkage connected a rotating portion of the swashplate assembly to each blade.

The swashplate assembly is typically movable in directions parallel to the shaft axis, to provide collective control. This movement causes the pitch angle of each of the blades to change the same amount in the same direction. The swashplate assembly may additionally be tilted about axes perpendicular to the shaft axis to provide cyclic control. Tilting of the swashplate assembly causes the pitch of each blade to change sinusoidally, or cyclically, as the rotor rotates, which causes the rotor to develop lift forces that vary across the plane defined by the rotor.

Multiple actuators coupled to the swashplate are configured to move the swashplate to provide both collective and cyclic control. Although in conventional systems, the actuators are typically hydraulic actuators, electrical actuators have started to be implemented in such systems. In the event of failure of one or more actuators, it is necessary to restrict relative motion of the actuators to maintain operation of the actuators within the constraints that limit movement of the swashplate.

### BRIEF DESCRIPTION OF THE INVENTION

According to one embodiment of the invention, a method of synchronizing a plurality of actuators includes sensing a position of the plurality of actuators associated with a swashplate and calculating a measured collective position and a measured cyclic position based on the sensed position. A collective position error and a cyclic position error are determined from the measured collective position and the measured cyclic position. The cyclic position error is compared to a predetermined threshold to evaluate whether operation of the plurality of actuators is within limits of the swashplate.

In addition to one or more of the features described above, or as an alternative, in further embodiments generating a collective position command and a cyclic position command in response to the comparison of the cyclic position error and the predetermined threshold.

In addition to one or more of the features described above, or as an alternative, in further embodiments the cyclic position command is equal to an input cyclic command generated in response to a pilot input.

In addition to one or more of the features described above, or as an alternative, in further embodiments if the cyclic position error is greater than the predetermined threshold, the collective position command is equal to the calculated collective position.

In addition to one or more of the features described above, or as an alternative, in further embodiments if the cyclic position error is less than or equal to the predetermined threshold, the collective position command is equal to an input collective command generated in response to a pilot input.

In addition to one or more of the features described above, or as an alternative, in further embodiments comprising converting the collective position command and the cyclic position command to corresponding actuator positions and communicating the corresponding actuator positions to the plurality of actuators.

In addition to one or more of the features described above, or as an alternative, in further embodiments determining the collective position error and the cyclic position error includes comparing the calculated collective position and cyclic position with an input collective command and an input cyclic command.

In addition to one or more of the features described above, or as an alternative, in further embodiments calculating the measured collective position and the measured cyclic position includes converting the sensed position of the plurality of actuators using kinematics equations.

In addition to one or more of the features described above, or as an alternative, in further embodiments the limits of the swashplate include at least one of structural, aerodynamic, and kinematics that limit movement of the swashplate.

According to another embodiment, a flight control system of an aircraft includes a rotor system having a swashplate and a plurality of actuators operable to move the swashplate. At least one sensor is configured to monitor a position of the plurality of actuators. An actuator synchronization system evaluates whether operation of the plurality of actuators is within limits of the swashplate. A flight control computer is operably coupled to actuator synchronization system. The flight control computer communicates commands to the plurality of actuators in response to the actuator synchronization system.

In addition to one or more of the features described above, or as an alternative, in further embodiments the actuator synchronization system includes a processor configured to run a synchronization algorithm.

In addition to one or more of the features described above, or as an alternative, in further embodiments the actuator synchronization system additionally includes a memory within which a predetermined error threshold is stored.

In addition to one or more of the features described above, or as an alternative, in further embodiments the actuator synchronization system is integrated within the flight control computer.

In addition to one or more of the features described above, or as an alternative, in further embodiments the flight control computer is configured to communicate at least one of a collective command and a cyclic command generated in response to a pilot input.

In addition to one or more of the features described above, or as an alternative, in further embodiments comprise an actuator control unit. The actuator control unit is arranged in communication with the actuator synchronization system. The actuator control unit is configured to communicate at least one of a collective command and a cyclic command generated in response to a pilot input.

In addition to one or more of the features described above, or as an alternative, in further embodiments the actuator synchronization system is configured to determine a collective position error and a cyclic position error for the plurality of actuators.

In addition to one or more of the features described above, or as an alternative, in further embodiments the actuator synchronization system is further configured to compare at least one of the collective position error and the cyclic position error relative to a predetermined threshold and generate a collective position command and a cyclic position command in response to said comparison.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of an example of a rotary wing aircraft;

FIG. 2 is a schematic diagram of a flight control system of an aircraft; and

FIG. 3 is a schematic diagram of a portion of an actuator synchronization system of a flight control system according to an embodiment.

The detailed description explains embodiments of the invention, together with advantages and features, by way of example with reference to the drawings.

### DETAILED DESCRIPTION OF THE INVENTION

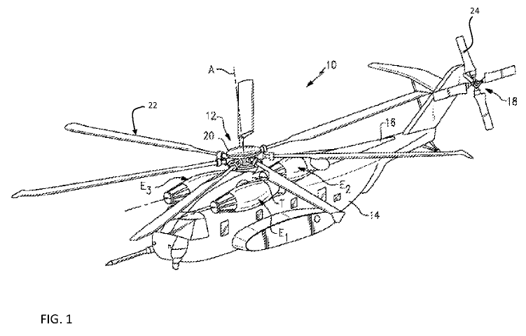

FIG. 1 schematically illustrates an example of a rotary wing aircraft 10 having a main rotor assembly 12. The aircraft 10 includes an airframe 14 having an extending tail 16 which mounts a tail rotor system 18, such as an anti-torque system, a translational thrust system, a pusher propeller, a rotor propulsion system, and the like. The main rotor assembly 12 includes a plurality of rotor blade assemblies 22 mounted to a rotor hub 20. The main rotor assembly 12 is driven about an axis of rotation A through a main gearbox (illustrated schematically at T) by one or more engines E. Although a particular helicopter configuration is illustrated and described in the disclosed embodiment, other configurations and/or machines, such as high speed compound rotary wing aircraft with supplemental translational thrust systems, dual contra-rotating, coaxial rotor system aircraft, tilt-rotors and tilt-wing aircraft, and fixed wing aircraft, will also benefit from embodiments of the invention.

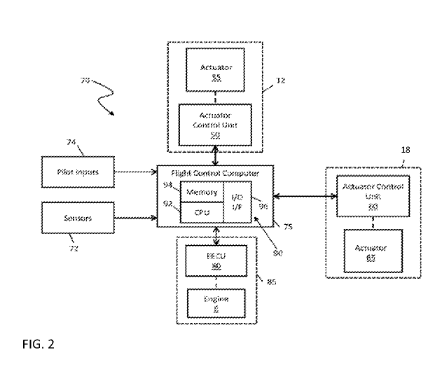

Portions of the aircraft 10, such as the main rotor system 12 and the tail rotor system 18 for example, are driven by a flight control system 70 illustrated in FIG. 2. In one embodiment, the flight control system 70 is a fly-by-wire (FBW) control system. In a FBW control system, there is no direct mechanical coupling between a pilot's controls and movable components or control surfaces, such as rotor blade assemblies 20 or propeller blades 24 for example, of the aircraft 10 of FIG. 1. Instead of using mechanical linkages, a FBW control system includes a plurality of sensors 72 which can sense the position of controlled elements and generate electrical signals proportional to the sensed position. The sensors 72 may also be used directly and indirectly to provide a variety of aircraft state data to a flight control computer (FCC) 75. The FCC 75 may also receive pilot inputs 74 as control commands to control the lift, propulsive thrust, yaw, pitch, and roll forces and moments of the various control surfaces of the aircraft 10.

In response to inputs from the sensors 72 and pilot inputs 74, the FCC 75 transmits signals to various subsystems of the aircraft 10, such as the main rotor system 12 and the tail rotor system 18. The FCC 75 can use reference values in the pilot inputs 74 for feed forward control to quickly respond to changes in the reference values and can perform feedback control to reject disturbances detected via the sensors 72. Pilot inputs 74 can be in the form of stick commands and/or beeper commands to set and incrementally adjust reference values for controllers. The pilot inputs 74 need not be directly provided by a human pilot, but may be driven by an automatic pilot, a remote control, a navigation-based control, or one or more outer control loops configured to produce one or more values used to pilot the aircraft 10.

The main rotor system 12 can include an actuator control unit 50 configured to receive commands from the FCC 75 to control one or more actuators 55, such as a mechanical-hydraulic actuator or an electric actuator for example, for the rotor blade assemblies 20 of FIGS. 1 and 2. In an embodiment, pilot inputs 74 including cyclic and/or collective commands may result in the actuator control unit 50 driving the one or more actuators 55 to adjust a swashplate assembly to control the rotor blade assemblies 20 of FIG. 1. Alternatively, the FCC 75 can directly control the one or more actuators 55, and the actuator control unit 50 can be omitted.

The tail rotor system 18 can include an actuator control unit 60 configured to receive commands from the FCC 75 to control one or more actuators 65, such as a mechanical-hydraulic actuator or an electrical actuator for example, associated with one or more propeller blades 24. In an embodiment, pilot inputs 74 include a propeller pitch command for the actuator control unit 60 to drive the one or more actuators 65 for controlling the propeller blades FIG. 1. Alternatively, the FCC 75 can directly control the one or more actuators 65, and the actuator control unit 60 can be omitted.

The FCC 75 can also interface with an engine control system 85 including one or more electronic engine control units (EECUs) 80 to control the engines E. Each EECU 80 may be a digital electronic control unit such as Full Authority Digital Engine Control (FADEC) electronically interconnected to a corresponding engine E. Each engine E may include one or more instances of the EECU 80 to control engine output and performance. Engines E may be commanded in response to the pilot inputs 74, such as a throttle command.

Rather than simply passing pilot inputs 74 through to various control units 50, 60, and 80, the FCC 75 includes a processing system 90 that applies models and control laws to augment commands. The processing system 90 includes processing circuitry 92, memory 94, and an input/output (I/O) interface 96. The processing circuitry 92 can be any type or combination of computer processors, such as a microprocessor, microcontroller, digital signal processor, application specific integrated circuit, programmable logic device, and/or field programmable gate array, and is generally referred to as central processing unit (CPU) 92. The memory 94 can include volatile and non-volatile memory, such as random access memory (RAM), read only memory (ROM), or other electronic, optical, magnetic, or any other computer readable storage medium onto which data and control logic as described herein are stored. Therefore, the memory 94 is a tangible storage medium where instructions executable by the processing circuitry 92 are embodied in a non-transitory form. The I/O interface 96 can include a variety of input interfaces, output interfaces, communication interfaces and support circuitry to acquire data from the sensors 72, pilot inputs 74, and other sources (not depicted) and may communicate with the control units 50, 60, 80, and other subsystems (not depicted).

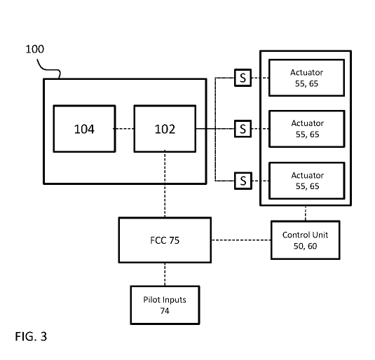

Referring now to FIG. 3, the flight control system 70 of the aircraft 10 may additionally include an actuator synchronization system 100 for monitoring the position of the plurality of actuators associated with an actuator control unit, such as the actuators 55, 65 configured to adjust the pitch of the main rotor system 12 and/or the tail rotor system 18 for example. The flight control computer 75 is configured to cooperate with the actuator synchronization system 100. Although the actuator synchronization system 100 is illustrated as being separate from the flight control computer 75, embodiments where the actuator synchronization system 100 is integrated with the flight control computer 75 are also contemplated herein. The actuator synchronization system 100 includes one or more sensors, illustrated schematically at S, associated with the one or more actuators 55, 65, coupled to a swashplate. The sensors S are configured to measure and communicate to the actuator synchronization system 100, in real time, the actual position of each of the plurality of actuators 55, 65.

The sensors S are operably coupled to a processor 102 of the actuator synchronization system 100. An algorithm, such as stored within a memory 104 accessible by the processor 102 for example, is used to convert the signals received from the one or more sensors S into calculated collective and cyclic positions using conventional kinematics equations. In addition, the collective and cyclic commands generated in response to the pilot inputs 74 are provided to the actuator synchronization system 100. The collective and cyclic commands may be communicated from the FCC 75, or alternatively from an actuator control unit 50, 60 associated with the plurality of actuators 55, 65. In another embodiment, the processor 102 may be configured to access collective and cyclic commands generated in response to the one or more pilot inputs 74 that are stored within the memory 104.

The synchronization algorithm operable by the processor 102 is configured to compare the collective and cyclic positions calculated based on the sensor data with the collective and cyclic commands generated in response to one or more pilot inputs 74 to determine a collective position error and a cyclic position error for each of the plurality of actuators 55, 65 associated with a rotor system. The processor 102 of the actuator synchronization system 100 is then configured to compare at least one of the position errors with a predetermined threshold. In an embodiment, the cyclic position error is compared to a predetermined threshold, such as stored within memory 104 for example, to evaluate whether operation of the actuators is within the limits of the swashplate. Relevant limitations of the swashplate include, but are not limited to, structural, aerodynamic, kinematic, or other constraints that limit movement of the swashplate.

The processor 102 is configured to output a collective position command and a cyclic position command in response to the comparison between the position error and the predetermined threshold. If the processor 102 determines that the cyclic position error is greater than the predetermined threshold, the collective position command is equal to the collective position calculated in response to the swashplate angle measured by the plurality of sensors. If the processor determines that the cyclic position error is less than or equal to the predetermined threshold, the collective position command generated by the processor 102 is equal to the collective command of the pilot inputs 74. Regardless of the outcome of the comparison of the cyclic position error relative to the predetermined threshold, the output cyclic position command is equal to the cyclic command generated in response to the pilot inputs 74. The collective position command and the cyclic position command output determined by the processor 102 are then converted to actuator position commands via kinematics equations and are communicated to the plurality of actuators 55, 65 with a rotor system.

The synchronization provided by the actuator synchronization system 100 reduces the amount of uncommanded motion that occurs between the plurality of actuators associated with a swashplate of a rotor system. In addition, in the event that one or more of the plurality of actuators fails, the commands generated by the system 100 reduced large asymmetrical loading that may exceed the structural limitations of the swashplate. Although the actuator synchronization system 100 is illustrated and described with respect to a rotor system, it should be understood that the system 100 may be used in other suitable applications having a plurality of actuators coupled to a component.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A method of synchronizing a plurality of actuators comprising:
sensing a position of the plurality of actuators associated with a swashplate;
calculating a measured collective position and a measured cyclic position based on the sensed position;
determining a collective position error and a cyclic position error from the measured collective position and the measured cyclic position; and
comparing the cyclic position error to a predetermined threshold to evaluate whether operation of the plurality of actuators is within limits of the swashplate

2. The method according to claim 1, further comprising generating a collective position command and a cyclic position command in response to the comparison of the cyclic position error and the predetermined threshold.

3. The method according to claim 2, wherein the cyclic position command is equal to an input cyclic command generated in response to a pilot input.

4. The method according to claim 2, wherein if the cyclic position error is greater than the predetermined threshold, the collective position command is equal to the calculated collective position.

5. The method according to claim 2, wherein if the cyclic position error is less than or equal to the predetermined threshold, the collective position command is equal to an input collective command generated in response to a pilot input.

6. The method according to claim 2, further comprising:
converting the collective position command and the cyclic position command to corresponding actuator positions; and
communicating the corresponding actuator positions to the plurality of actuators.

7. The method according to claim 1, wherein determining the collective position error and the cyclic position error includes comparing the calculated collective position and cyclic position with an input collective command and an input cyclic command.

8. The method according to claim 1, wherein calculating the measured collective position and the measured cyclic position includes converting the sensed position of the plurality of actuators using kinematics equations.

9. The method according to claim 1, wherein the limits of the swashplate include at least one of structural, aerodynamic, and kinematics that limit movement of the swashplate.

10. A flight control system of an aircraft comprising:
a rotor system including a swashplate and a plurality of actuators operable to move the swashplate;
at least one sensor configured to monitor a position of the plurality of actuators;
an actuator synchronization system configured to evaluate whether operation of the plurality of actuators is within limits of the swashplate; and
a flight control computer operably coupled to actuator synchronization system, the flight control computer being configured to communicate commands to the plurality of actuators in response to the actuator synchronization system.

11. The system according to claim 10, wherein the actuator synchronization system includes a processor configured to run a synchronization algorithm.

12. The system according to claim 11, wherein the actuator synchronization system additionally includes a memory within which a predetermined error threshold is stored.

13. The system according to claim 10, wherein the actuator synchronization system is integrated within the flight control computer.

14. The system according to claim 10, wherein the flight control computer is configured to communicate at least one of a collective command and a cyclic command generated in response to a pilot input.

15. The system according to claim 10, further comprising an actuator control unit, the actuator control unit being arranged in communication with the actuator synchronization system, wherein the actuator control unit is configured to communicate at least one of a collective command and a cyclic command generated in response to a pilot input.

16. The system according to claim 10, wherein the actuator synchronization system is configured to determine a collective position error and a cyclic position error for the plurality of actuators.

17. The system according to claim 16, wherein the actuator synchronization system is further configured to compare at least one of the collective position error and the cyclic position error relative to a predetermined threshold and generate a collective position command and a cyclic position command in response to said comparison.
